(19) United States
(12) Patent Application Publication
(10) Pub. No.: US 2007/0094844 A1
(43) Pub. Date: May 3, 2007

(54) Metallic hinge motion check friction device including a one-piece design, methods incorporating the device, and uses thereof

(75) Inventor: Kenneth W. Nelson, South Lyon, MI (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(73) Assignee: E. I. DU PONT DE NEMOURS AND COMPANY

(21) Appl. No.: 11/507,413

(22) Filed: Aug. 21, 2006

Related U.S. Application Data
(60) Provisional application No. 60/710,317, filed on Aug. 22, 2005.

(51) Int. Cl. E05D 11/08

(52) U.S. Cl. 16/337

(57) ABSTRACT

All-metal hinge motion check friction device for incorporating into a hinge assembly useful for holding a hinge open at a selected position. The hinge motion check friction device is useful for incorporating into vehicle door hinges, particularly when the vehicle is being painting during manufacturing.

### CROSS REFERENCE TO RELATED APPLICATIONS

This application claims the benefit of U.S. Provisional Application No. 60/710,317, filed Aug. 22, 2005.

### FIELD OF THE INVENTION

The present invention relates to an all-metal hinge motion check friction device for incorporating into a hinge assembly for holding a hinge open at a selected position. In particular, the present invention is useful for incorporating into vehicle door hinges, particularly when the vehicle is being painted during manufacturing, so that the door remains in a desirable fixed position to facilitate painting operations.

### BACKGROUND OF THE INVENTION

Hinges are widely used to connect two or more members, allowing them to rotate relative to one another. Examples of the use of hinges include connecting lids to containers and doors to frames. They are often designed to rotate relatively freely between preset stopping points, such as fully open or fully closed positions. However, in many instances it would be desirable to be able to reversibly position the members at a selected position relative to one another in such a way that they are both held in position and do not further rotate relative to each other. To accomplish this it would be beneficial to incorporate a hinge design such that the members connected by the hinge can first withstand the relatively low outside forces, such as the sometimes jerky movement of a conveyor line moving along an unpainted car body with its doors open by as much as 70 degrees in the assembly plant. Further with such a hinge the members retain their positions relative to each other when subjected to this movement, but can be further moved to other selected positions by the use of a force that is greater than that experienced by the members during , say, the above-mentioned assembly line movement acting on the open doors. By “reversibly position” is meant that the members can be repeatedly moved relative to one another from the position in which they were initially placed, and maintained in that subsequent position regardless of movement of the body to which the members are attached.

The use of such a hinge device would be particularly useful in vehicle doors, and in particular during the vehicle manufacturing process. During manufacturing, vehicles such as automobiles are often painted in a multi-step process on assembly lines. During the painting process, it is often necessary to open, close, and otherwise adjust the positions of doors connected to the bodies of vehicles by hinges relative to the bodies, often in an automated fashion by robots.

A variety of devices and techniques incorporating metal have been used in the past to position hinged members. Metal is an attractive material because it can withstand the forces encountered in moving hinged members along assembly lines. For example, previous attempts using metal assembly include positioning doors to be placed and held in desired positions using wire forms or metal brackets. However in such instances these supports must be individually installed, adjusted, and removed, which requires intervention by a worker and thus adds complexity to the painting process. Furthermore, after a few cycles in the painting process, it is often necessary to clean the supports, making this technique still more complex and labor-intensive.

It is known in the automotive construction process to use designs which incorporate tightly fitting plastic collar devices around a vehicle door hinge pin, and these collar devices are intended to provide resistance to door rotation. For example, such plastic collar devices have been observed on current production Ford F-150 pickup trucks. However, during the painting process, the vehicles can go through several heating and cooling steps during which the maximum temperature can reach or exceed 120° C., which can cause the plastic collar to lose its grip on the hinge pin as the plastic is annealed and expands and contracts during the heating and cooling cycles. This can lead to inconsistent and unreliable operation of the device as it will often fail to hold the door firmly in a desired position. All-metal designs are not necessarily limited in this manner, and therefore a metal device that can withstand several heating and cooling cycles without losing its grip on a hinge pin would be desirable.

It is an object of the present invention to obtain an all-metal device capable of holding two members connected by one or more hinges in a selected position between or including fully open (meaning the hinge surfaces maintain the members as far apart as possible) or fully closed (meaning that the hinge surfaces maintain the members in closest proximity to one another) that did not require the use of supports that must be manually removed and reinstalled each time the position of the members needed to be changed. It is a further object of the present invention to provide an all-metal device that does not incorporate plastic collars as mentioned above, instead providing a simple design which can withstand the rigors of automated assembly line processes, including paint baking or other high temperature exposure without significant degradation of its original frictional resistance to movement. A feature of the present invention is in one embodiment the use of such a device in a vehicle door hinge assembly. An advantage of the present invention is that such a device can maintain its predetermined position while experiencing the forces imparted on the vehicle body and the resultant inertial forces on an open door by the jerky motion of starting and stopping of many conveyer operations by not preventing the vehicle door from moving significantly from its set position, even after being exposed to several consecutive high temperature paint baking cycles. These and other objects, features and advantages of the invention will become better understood upon having reference to the detailed description herein.

### SUMMARY OF THE INVENTION

There is disclosed and claimed herein a hinge motion check friction device for holding a hinge connecting at least two members at an arbitrary position with a hinge pin, comprising a metal sleeve containing an opening into which is inserted the hinge pin and frictionally secures the hinge members in the position selected, and an integral metal tab projecting laterally from said metal sleeve which maintains the hinge members in the position selected.

Alternatively there is disclosed and claimed herein an improvement for an all-metal device for frictionally connecting hinge members at a selected position, comprising a metal sleeve containing an opening into which is inserted the hinge pin. The improvement comprises said metal sleeve frictionally securing the hinge members in the position selected, and a metal tab projecting laterally from said metal sleeve which maintains the hinge members in the position selected.

The present invention will become better understood upon having reference to the drawings herein.

### BRIEF DESCRIPTION OF THE DRAWINGS

FIGS. 1A and B are side and top views respectively, of a design of a metal friction device according to the invention;

FIGS. 2A and B are side and top views respectively, of an alternative design of a metal friction device according to the invention; and

FIGS. 3A and B are side and top views respectively, of a still further alternative design of a metal friction device according to the invention.

### DETAILED DESCRIPTION OF THE INVENTION

The friction device of the present invention comprises a metal sleeve such as a metal split tubular sleeve and through which a hinge pin connecting two or more hinge members is inserted, such that once positioned within the assembly, the metal sleeve is rotationally fixed to the hinge pin and cannot rotate within the assembly. The hinge pin is interlocked with one of the hinge members. The metal sleeve comprises a metal tab projecting laterally from the metal sleeve and that interlocks one or more hinge members that are different from the hinge member to which the hinge pin is interlocked, thus impeding relative motion of the hinge members. As used herein, by the term “interlocked”, it is meant that whenever a first part is in intimate contact with a second, separate part, any force applied to the first part to create movement in a particular direction causes simultaneously an equal movement of the second part in the same general direction.

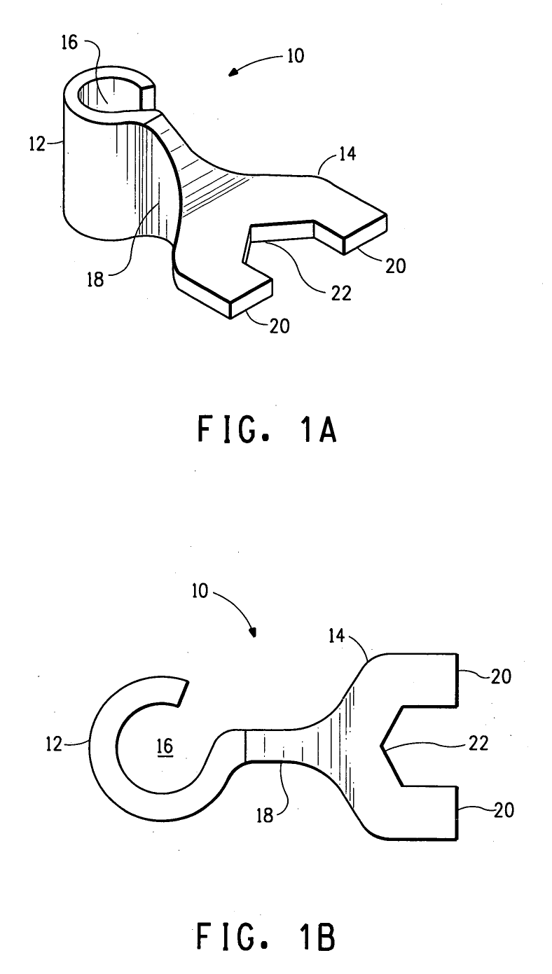

Having reference to FIGS. 1A and B, there is shown generally at 10 the friction device of the present invention, comprising a metal sleeve 12 and a metal tab 14 projecting laterally therefrom. The metal sleeve 12 is provided with opening 16 through which the hinge pin extends. The metal tab 14 can be broken off the slotted cylindrical body of the metal sleeve 12 by placing the slotted end of a special tool over the metal tab 14 and twisting the tool to shear off the metal tab 14 at the narrow transition area 18 between the metal tab 14 and the cylindrical friction portion of this device. In the embodiment depicted in these figures, the metal tab 14 comprises two leading edge portions 20 and a recessed area 22 therebetween.

In use a vehicle door hinge pin (not shown) may be inserted through the center of the friction device 10. The hinge pin fastens a door-side hinge member (which is secured to a door by fastening means not shown) to a body-side hinge member (which is secured to a body by fastening means also not shown). The configuration of the metal sleeve 12 and opening 16 is sized to accommodate the insertion of the hinge pin. The hinge pin may include a tapered end to facilitate this insertion. When the hinge pin is inserted through the friction device 10, the metal sleeve 12 expands in diameter, creating significant friction between friction device 10 and the hinge pin, such that the friction device 10 does not freely rotate around the hinge pin.

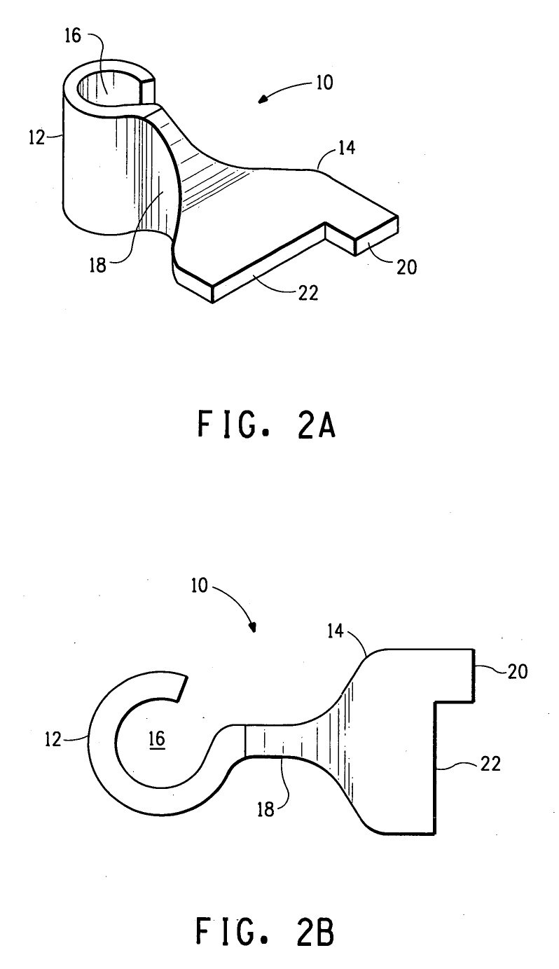

Having reference to FIGS. 2A and B, there is shown again generally at 10 an alternative embodiment of the device as depicted in FIGS. 1A and B, but featuring only one leading edge portion 20 in combination with a recessed area 22. In the designs of all such devices shown in the figures disclosed herein, and when incorporated into an assembly as described above, the hinge pin inserted through friction device 10 and the door-side hinge member and the body-side hinge member. One or more assembled hinges may be used to attach a vehicle door to the body of a vehicle, preferably an automobile. Preferably, the door-side member will be attached to the door and the body-side hinge member will be attached to the body. Metal tab 14 is designed such that it contacts either door-side hinge member or body-side hinge member 22, and serves as an interlock to couple the frictional resistance to rotation in either direction between the friction device 10 and hinge pin. In so-doing, the metal tab 14 transfers a rotational force from the door hinge, forcing the friction device 10 to rotate around the hinge pin to follow the door and overcoming the friction between the friction device 10 and hinge pin in the process. In one embodiment of the present invention, contact between metal tab 14 and the hinge member may be through a hole in the hinge member into which the metal tab 14 is inserted.

The hinge pin is interlocked to one of the hinge members. When metal tab 14 is designed such that it contacts the door-side hinge member, the hinge pin is interlocked with the body-side hinge member. When metal tab 14 is designed such that it contacts the body-side hinge member, the hinge pin is interlocked with the door-side hinge member. The hinge pin may be interlocked with the appropriate hinge member by serrations, scoring, grooves, or other details present in on the hinge pin that mate with complimentary serrations, scoring, groove, or other details on the hinge member when the hinge pin is inserted into the hinge member. Any other suitable method of interlocking the hinge pin to the hinge member may also be employed. When sufficient force is applied to the hinge, the door-side hinge member will rotate relative to the body-side hinge member. However, the frictional resistance is great enough that absent such force, the door-side hinge member and body-side hinge member will maintain their relative positions, particularly when used to mount a vehicle door to a vehicle that is conveyed along a painting line. As the vehicle moves along the painting line, the position of the door may be adjusted as needed by the application of force sufficient to overcome the frictional resistance between friction device 10 and hinge pin. However, the frictional resistance will be sufficient to keep the door in place when subjected to normal motion along the line, which can include jolts from starting and stopping the line, even after subjected to repeated heating and cooling cycles.

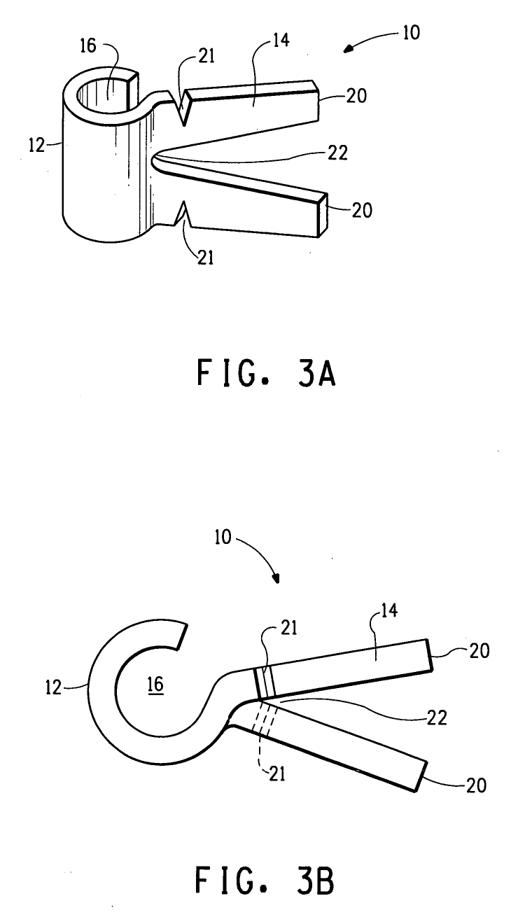

FIGS. 3A and B provide yet another alternative design for the metal friction device of the invention, again as shown generally at 10. This design features similar components as in the designs of the earlier figures, with the cylindrical friction body of the device gripping a hinge pin tightly, thereby providing essential friction to hold a door in the position in which it is preferentially placed. In this case the metal tab 14 includes bifurcated leading edges 20 which engage the edge of the hinge until one or both tabs are broken off by twisting the tab end beyond the v-notch 21 provided therealong. The v-notch 21 allows breaking off one or both tabs from cynlidrical friction body by twisting the tab 14 beyond the v-notch 21. Breaking of a tab 14 disconnects the friction device from the hinge half. As can be seen in FIG. 3B, the metal tabs 14 are separated by space so tha the edge of the hinge can bit between tabs and the force the friction device to rotate on the hinge pin.

Metal tab 14 is designed such that it may be conveniently removed from contacting a hinge member when it is no longer desirable to hold the hinge members in a selected position, such as when free motion between the members is desired. As shown in each of the Figures, the metal tab 14 is preferably connected to metal sleeve 12 by a narrow transition area 18. This allows metal tab 14 to be conveniently broken or cut off when, for example, the painting/assembly operation of a vehicle is complete. It is readily appreciated that other designs of the metal tab 14 can be incorporated to allow convenient breakage. For example, the surface thereof may be pre-scored sufficiently prepare it for breakage. Alternatively the metal tab 14 may be shaped as to introduce other weak points along the surface thereof, so that when subjected to torsional or flexural forces the metal will reliably and predictably break at a designated location therealong. Moreover and as introduced earlier the metal tab 14 can be broken off, by cutting with a suitable tool, and the like. When the metal tab 14 is broken off, the friction device is no longer interlocked with door-side hinge 20, allowing the door to move freely about its hinges thereafter, as would be preferred for normal use of the vehicle after assembly. The remainder of the device may remain present as part of hinge assembly during the life of the vehicle. Moreover because the remainder of the device is frictionally engaged with the hinge pin it is secured within the vehicle and does not contribute to the noise within the occupant compartment. Alternatively, metal tab 14 may be bent such that it no longer contacts hinge members.

The metal tab 14 will preferably be formed as an integral part of metal sleeve 12. Alternatively, the metal tab 14 may be made from one or more pieces of metal that have been designed to fit together as an integral metal part. The metal tab 14 may also be snap-fit or press-fitted or welded to the metal sleeve 12. In certain variants of this embodiment, the metal tab 14 may be removed without breakage and could be reusable. In addition, the metal tab 14 may extend along the length of the metal sleeve 12 or at one or more portions thereof, so long as it contacts the door side hinge member or the body side hinge member as appropriate. Such a sleeve design is sufficiently rigid for structural integrity while at the same time sufficiently flexible to accommodate the hinge pin.

Metal sleeve 14 will preferably be made from steel, and more preferably steel that has been treated to give it a spring-like quality.

The degree of friction, and hence resistance to rotation, between friction device 10 and the hinge pin can be adjusted by a variety of means, including varying the difference between the inner diameter of metal sleeve 12 and the diameter of the hinge pin; by increasing the wall thickness of metal sleeve 12; by altering the length of metal sleeve 12; by altering the heat and/or surface treatment of metal sleeve 12; and/or by changing the alloy of the metal, preferably steel, used to make the metal sleeve 12. Other approaches include changing the characteristics of the hinge pin, such as surface hardness, type of metal, and/or applying a special plating or coating. Therefore one of sufficient skill in the art to which the invention pertains can with little or no advance experimentation design into the friction device 10 the appropriate degree of friction to suit a specific purpose.

The force required to rotate a hinge pin inserted into device 10 of the present invention is preferably about 5 to about 60 N-m, or more preferably about 15 to about 35 N-m. when deployed for purposes of holding automobile doors in a selected position during the vehicle manufacturing process. For other purposes the preferred force will vary according to the application selected.

What is claimed is:

1. A hinge motion check friction device for holding a hinge connecting at least two members at an arbitrary position with a hinge pin, comprising a metal sleeve containing an opening into which is inserted a hinge pin and frictionally secures the hinge members in the position selected, and a metal tab projecting laterally from said metal sleeve which maintains the hinge members in the position selected.

2. In an all-metal device for frictionally connecting hinge members at a selected position, comprising a metal sleeve containing an opening into which is inserted a hinge pin, the improvement comprising said metal sleeve frictionally securing the hinge members in the position selected, and an integral metal tab projecting laterally from said metal sleeve which maintains the hinge members in the position selected.

3. The device of claim 2 wherein the device connects a vehicle door to a vehicle body and holds the door in a selected position relative to the body.

4. A hinge comprising a hinge pin connecting two or more hinge members and interlocked to one of the members, such that the hinge members pivot relative to each other around the hinge pin and wherein the hinge pin is inserted into a hinge motion check friction device comprising a metal sleeve containing an opening into which is inserted the hinge pin and frictionally secures the hinge members in the position selected, so that the relative motion of the hinge pin and metal sleeve is impeded by friction resistance, and wherein said metal sleeve further comprises a metal tab secured to said metal sleeve and which maintains the hinge members in the position selected, and the metal tab that is in contact with a hinge member different from the one to which the hinge pin is interlocked, such that relative motion of the hinge members is impeded.

5. The hinge of claim 4 wherein the hinge pin connects a hinge member attached to a vehicle door and a hinge member attached to a vehicle body.

6. A method of holding a vehicle door at an selected open position relative to a vehicle body to which the door is attached via at least one hinge having a hinge pin during a painting process, comprising inserting the hinge pin through an opening in a hinge motion check friction device comprising a metal sleeve in contact with the hinge pin such that the relative motion of the hinge pin and metal sleeve is impeded by friction resistance, wherein the hinge comprises a member attached to the door and member attached to the body, such that the hinge members are connected by and pivot relative to each other around the hinge pin, and wherein said metal sleeve further comprises a tab that is brought into contact with the member attached to the door or the member attached to the body and the hinge pin is interlocked with a hinge member different from the one to which the tab is brought into contact with, such that relative motion of the hinge members is impeded.

7. A method of painting the body of a vehicle to which is attached at least one door, comprising inserting the hinge pin through an opening in a hinge motion check friction device comprising a metal sleeve in contact with the hinge pin such that the relative motion of the hinge pin and metal sleeve is impeded by friction resistance, wherein the hinge comprises a member attached to the door and member attached to the body, such that the hinge members are connected by and pivot relative to each other around the hinge pin, and wherein the metal sleeve further comprises a tab that is brought into contact with the member attached to the door or the member attached to the body and the hinge pin is interlocked with a hinge member different from the one to which the tab is brought into contact with, such that relative motion of the hinge members is impeded; opening the door to a predetermined position; and painting the vehicle body and/or door.

8. The hinge of claim 4 wherein a force of about 5 to about 60 N-m is required to rotate the hinge pin within the hinge motion check friction device.
